(19) United States
(12) Patent Application Publication
(10) Pub. No.: US 2026/0285595 A1
(43) Pub. Date: Sep. 24, 2026

(54) Transport Facility

(71) Applicant: Daifuku Co., Ltd., Osaka-shi (JP)

(72) Inventors: Masashige Iwata, Hinocho (JP); Kazunari Kimura, Hinocho (JP); Hiroaki Nakamura, Hinocho (JP)

(21) Appl. No.: 18/843,120

(22) PCT Filed: Feb. 28, 2023
(86) PCT No.: PCT/JP2023/007191

§ 371 Date: May 8, 2026

(30) Foreign Application Priority Data
Mar. 1, 2022 (JP) 2022-030849

(51) Int. Cl. B65G 1/137; B65G 1/04; B65G 1/127

(52) U.S. Cl. CPC B65G 1/137; B65G 1/0492; B65G 1/127

(57) ABSTRACT

When transporting a target article (9) to a carry-out section (7) using a transport cart (1), if an empty dual-zone temporary storage section (6m) is present downstream of a target holding section (50) in a first zone (21), a control system executes relay carry-out processing. In the relay carry-out processing, the empty dual-zone temporary storage section (6m) is set as a first target temporary storage section (61t), the target article (9) is received from the target holding section (50) and passed to the first target temporary storage section (61t) in the first zone (21), and then the target article (9) is received from the first temporary storage section (61t) in a second zone (22) and passed to the carry-out section (7).

### CROSS-REFERENCE TO RELATED APPLICATIONS

This application is the United States national phase of International Patent Application No. PCT/JP2023/007191 filed Feb. 28, 2023, and claims priority to Japanese Patent Application No. 2022-030849 filed Mar. 1, 2022, the disclosures of which are hereby incorporated by reference in their entireties.

### BACKGROUND OF THE INVENTION

### Field of the Invention

The present invention relates to a transport facility that includes transport carts for transporting articles, a transport path along which the transport carts move in one direction, a carry-out section for carrying out articles, and a control system for controlling the transport carts.

### Description of Related Art

One example of such a transport facility is disclosed in Japanese Patent No. 6461359. In the following description of the background art, the reference symbols in parentheses are those used in Japanese Patent No. 6461359.

The transport facility disclosed in Japanese Patent No. 6461359 includes a plurality of transport carts (110) for transporting articles (30), a loop-shaped transport path (100) along which the transport carts (110) move in a loop, a carry-in section (201) for carrying in articles (30) to the transport path (100), a carry-out section (401) for carrying out articles (30) from the transport path (100), and a buffer (600) for temporarily storing articles (30) at positions adjacent to the transport path (100).

In the transport facility disclosed in Japanese Patent No. 6461359, articles (30) are carried in to the transport path (100) in the order in which the articles arrive at the carry-in section (201). If the order of arrival is different from the originally intended normal order, processing is performed in the transport path (100) to rearrange the order of the articles (30) to the normal order. Specifically, a mode (a) for overtaking a preceding article (30) that entered the transport path (100) at an earlier time is executed by performing bypass transport in which an article (30) is transferred between two transport carts (110) horizontally adjacent to each other on the transport path (100). As a result, the article (30) that entered the transport path (100) at a later time is moved forward in the order. It is also possible to execute a mode (b) in which a preceding article (30) that entered the transport path (100) at an earlier time is temporarily stored in the buffer (600) and waits until an article (30) that entered the transport path (100) at a later time passes the preceding article (30). As a result, the preceding article (30) that entered the transport path (100) at an earlier time is moved backward in the order.

As described above, in the transport facility disclosed in Japanese Patent No. 6461359, processing is performed to rearrange the order of articles (30) in the transport path (100) to the normal order. However, Japanese Patent No. 6461359 does not provide any detailed disclosure on how to improve the overall transport efficiency of the facility.

### SUMMARY OF THE INVENTION

In view of the above circumstances, it is desirable to improve the overall transport efficiency in a transport facility that includes a loop path along which transport carts move in one direction in a loop.

A transport facility according to an aspect of the present invention includes:
a first transport cart configured to transport an article;
a transport path along which the first transport cart moves in one direction;
a holding device including a plurality of holding sections configured to hold articles successively transported to the holding sections;
a carry-out section configured to perform article carry-out; and
a control system configured to control the first transport cart,
the transport path forming a loop path along which the first transport cart passes a carry-out position corresponding to the carry-out section while moving in one direction in a loop,
the transport path including:
   a first zone set downstream of the carry-out position; and
   a second zone set downstream of the first zone and upstream of the carry-out position, and extending parallel with the first zone while being spaced apart from the first zone in a specific direction,
the plurality of holding sections being arranged in a line along the first zone,
the transport facility further including a plurality of temporary storage sections arranged along the transport path and configured to temporarily store articles,
the plurality of temporary storage sections including a plurality of dual-zone temporary storage sections arranged in a line along both the first zone and the second zone at positions between the first zone and the second zone in the specific direction, and
the first transport cart being further configured to perform article transfer with the plurality of holding sections, the plurality of temporary storage sections, and the carry-out section at positions corresponding thereto along the transport path,
wherein with a target article being one of the articles held by the plurality of holding sections, a non-target article being an article other than the target article among the articles held by the plurality of holding sections, a target holding section being the holding section in which the target article is held, and a non-target holding section being the holding section in which the non-target article is held,
in a case where the target article is to be transported to the carry-out section by the first transport cart, in response to presence of an empty dual-zone temporary storage section downstream of the target holding section in the first zone, the control system executes, using the first transport cart, relay carry-out processing including setting the empty dual-zone temporary storage section as a first target temporary storage section, receiving the target article from the target holding section and passing the target article to the first target temporary storage section in the first zone, and then receiving the target article from the first target temporary storage section in the second zone and passing the target article to the carry-out section, and
while the control system executes the relay carry-out processing, in response to presence of the non target holding section downstream of a position where the target article was passed to the first target temporary storage section in the first zone and presence of an empty temporary storage section downstream of the non-target holding section and upstream of a position where the target article is to be received from the first target temporary storage section in the second zone, the control system executes, using the first transport cart, intermediate transport processing including setting the empty temporary storage section as a second target temporary storage section, and, during the relay carry-out processing, receiving the non-target article from the non-target holding section and passing the non-target article to the second target temporary storage section.

According to this configuration, the target article can be temporarily placed in a temporary storage section that is closer to the carry-out section than the holding section is. After placing the target article in the temporary storage section, while moving without transporting the target article, the transport cart can receive a non-target article from a holding section and place the non-target article in another temporary storage section. Thereafter, the transport cart can receive the target article that was placed in the temporary storage section in the second zone, and appropriately transport the target article to the carry-out section. In the above, the non-target article placed in another temporary storage section can become a target article for another transport cart, thus making it possible to shorten the transport distance traveled by the other transport cart to transport the non-target article to the carry-out section. In this way, according to the above configuration, the target article can be appropriately transported from the target holding section to the carry-out section, and the non-target article can be moved to a position closer to the carry-out section while the transport cart moves along the path from the target holding section to the carry-out section. Therefore, it is possible to improve the overall transport efficiency when transporting articles to the carry-out section in the facility.

Further features and advantages of technology disclosed herein will become more apparent from the following description of exemplary and non-limiting embodiments, which are described with reference to the drawings.

### BRIEF DESCRIPTION OF THE DRAWINGS

FIG. 1 is a side view of a transport facility.

FIG. 2 is a side view of a transport cart.

FIG. 3 is a control block diagram.

FIG. 4A is an illustrative diagram of processing executed in Case 1.

FIG. 4B is an illustrative diagram of processing executed in Case 1.

FIG. 5 is an illustrative diagram of processing executed in Case 2.

FIG. 6A is an illustrative diagram of processing executed in Case 3.

FIG. 6B is an illustrative diagram of processing executed in Case 3.

FIG. 7 is an illustrative diagram of a case in which temporary storage section reservation processing is executed.

FIG. 8A is an illustrative diagram of a case in which group retrieval processing is executed.

FIG. 8B is an illustrative diagram of a case in which group retrieval processing is executed.

FIG. 9 is a flowchart showing steps of processing executed by a control system.

### DESCRIPTION OF THE INVENTION

A transport facility is a facility for transporting articles. The articles to be transported may be a container (such as a folding container or a cardboard box) for holding a product, a pallet on which a product is placed, or the product itself. Note that the product may be a finished product or an unfinished product. Hereinafter, embodiments of the transport facility will be described with reference to the drawings.

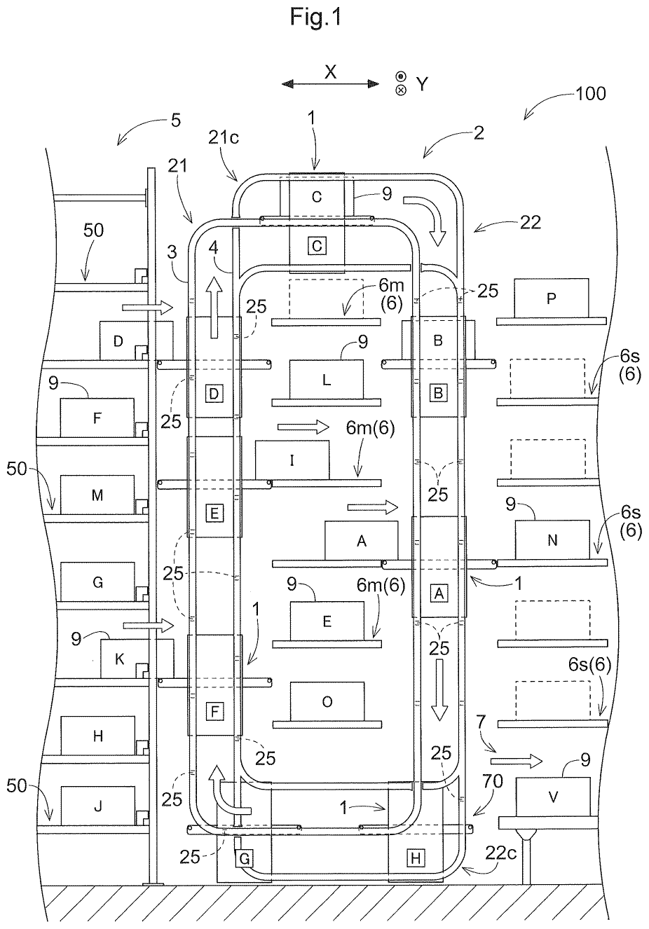

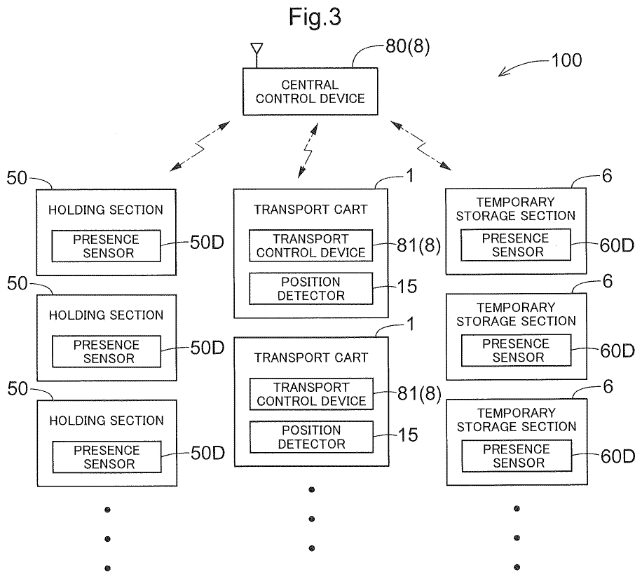

As shown in FIG. 1, a transport facility 100 includes transport carts 1 that transport articles 9, a transport path 2 along which the transport carts 1 move in one direction, a holding device 5 that includes a plurality of holding sections 50 that hold articles 9 sequentially conveyed thereto, a carry-out section 7 that carries out articles 9, and a control system 8 (see FIG. 3) that controls the transport carts 1. In the present embodiment, the transport facility 100 includes a plurality of transport carts 1.

The transport path 2 forms a loop path along which the transport carts 1 pass a carry-out position 70 corresponding to the carry-out section 7 while moving in one direction in a loop, and includes a first zone 21 set downstream of the carry-out position 70 (downstream in the transport direction, which similarly applies hereinafter), and a second zone 22 that is set downstream of the first zone 21 and upstream of the carry-out position 70 (upstream in the transport direction, which similarly applies hereinafter) and that extends parallel with the first zone 21 while being spaced apart therefrom in a specific direction X.

In the present embodiment, the transport path 2 forms a loop path along which the transport carts 1 move in a loop in a vertical plane. The first zone 21 and the second zone 22 of the transport path 2 extend in the up-down direction. In this example, the transport path 2 includes a first connection zone 21c and a second connection zone 22c that extend in the specific direction X. The first connection zone 21c and the second connection zone 22c each connect the first zone 21 and the second zone 22 to each other. In this example, the first connection zone 21c and the second connection zone 22c are spaced apart from each other in the up-down direction. The first connection zone 21c connects the upper end of the first zone 21 and the upper end of the second zone 22 to each other. The second connection zone 22c connects the lower end of the first zone 21 and the lower end of the second zone 22 to each other.

In the following description, the above-mentioned “specific direction X” is a specific direction along the horizontal plane, and an “orthogonal direction Y” is a direction orthogonal to the specific direction X in a planar view. In this example, the horizontal direction orthogonal to the specific direction X is defined as the orthogonal direction Y.

In the present embodiment, the transport path 2 includes a pair of drive rails 3 spaced apart from each other in the orthogonal direction Y, and a pair of auxiliary rails 4 spaced apart from each other in the orthogonal direction Y. In this example, the drive rails 3 and the auxiliary rails 4 extend along the first zone 21, the first connection zone 21c, the second zone 22, and the second connection zone 22c, and form a loop when viewed in the orthogonal direction Y. The drive rails 3 and the auxiliary rails 4 are offset from each other while also partially overlapping each other (at four locations in the illustrated example) when viewed in the orthogonal direction Y.

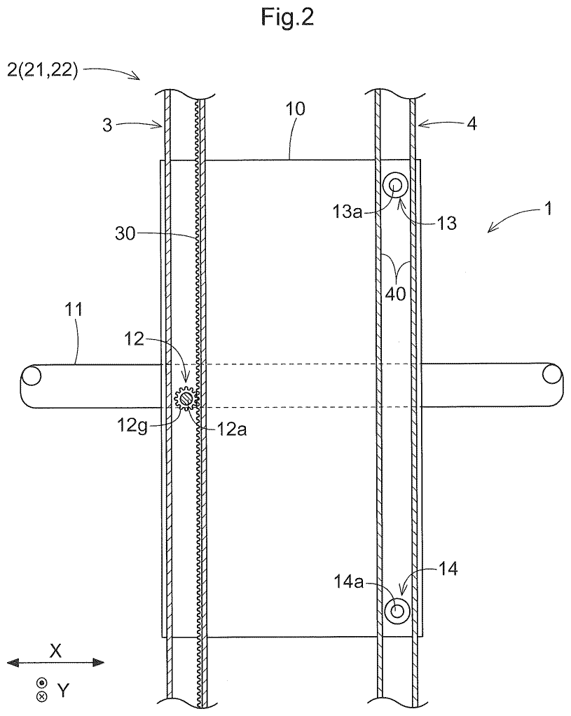

As shown in FIG. 2, the drive rails 3 guide later-described drive wheels 12 of the transport cart 1. In the present embodiment, each of the drive rails 3 has a rail gear section 30 that extends along the transport path 2. The rail gear section 30 meshes with the drive wheel 12 of the transport cart 1. In the illustrated example, the drive rail 3 has an internal space in which the drive wheel 12 of the transport cart 1 is disposed. The rail gear section 30 is provided on an inward surface of the drive rail 3.

In the present embodiment, the auxiliary rails 4 guide a first auxiliary wheel 13 and a second auxiliary wheel 14 of the transport cart 1, which will be described later. Each of the auxiliary rails 4 has a pair of guide surfaces 40 that extend along the transport path 2. In the illustrated example, the auxiliary rail 4 has an internal space in which the first auxiliary wheel 13 and the second auxiliary wheel 14 of the transport cart 1 are disposed. The pair of guide surfaces 40 face each other in a direction orthogonal to the rail extending direction, in the internal space of the auxiliary rail 4. The gap between the pair of guide surfaces 40 in the direction orthogonal to the rail extending direction is set to a distance such that the first auxiliary wheel 13 and the second auxiliary wheel 14 do not come into contact with both of the guide surfaces 40 at the same time. The pair of guide surfaces 40 are arranged on opposite sides of the first auxiliary wheel 13 and the second auxiliary wheel 14 of the transport cart 1 in the internal space of the auxiliary rail 4.

As shown in FIG. 1, the holding device 5 is adjacent to one side of the transport path 2 in the specific direction X. The holding sections 50 are arranged in a line along the first zone 21. In the present embodiment, the holding sections 50 are arranged in a line in the up-down direction. Each of the holding sections 50 is a transfer target location at which an article 9 can be transferred to or from a transport cart 1 moving on the transport path 2. The holding device 5 is a device for the retrieval of articles 9 stored in an automated warehouse, for example. In this case, articles 9 that are to be retrieved from the automated warehouse are successively conveyed to the holding sections 50.

Each of the holding sections 50 can transport an article 9 along the specific direction X. Accordingly, each of the holding sections 50 is capable of sequentially transporting an article 9 to a position adjacent to the transport path 2 and also capable of passing the article 9 to the transport cart 1. For example, each of the holding sections 50 includes a conveyor that transports the article 9 along the specific direction X.

In the present embodiment, each of the holding sections 50 includes a presence sensor 50D (see FIG. 3) that detects the presence or absence of an article 9. As will be described later, information on the presence or absence of an article 9 in the holding section 50 detected by the presence sensor 50D is transmitted to the control system 8.

The carry-out section 7 is a transfer target location at which an article 9 can be transferred to or from a transport cart 1 moving on the transport path 2. The carry-out section 7 is arranged at a position corresponding to one of several positions along the transport path 2. In this example, the carry-out section 7 is disposed on the side of the transport path 2 opposite to the holding device 5 in the specific direction X. In other words, as described above, the holding device 5 is disposed adjacent to one side of the transport path 2 in the specific direction X. The carry-out section 7 is disposed adjacent to the other side of the transport path 2 in the specific direction X.

The carry-out section 7 can transport the articles 9 along the specific direction X. Accordingly, the carry-out section 7 can appropriately receive an article 9 from a transport cart 1 and transport the received article 9 to the location where the next step is to be performed (e.g., a location where picking work is performed to retrieve a product from the article 9). For example, the carry-out section 7 includes a conveyor for transporting the articles 9 along the specific direction X.

A plurality of temporary storage sections 6 capable of temporarily storing articles 9 are arranged along the transport path 2. Each of the temporary storage sections 6 is a transfer target location at which an article 9 can be transferred to or from a transport cart 1 moving on the transport path 2. An article 9 that the transport cart 1 receives from a holding section 50 can be temporarily stored in a temporary storage section 6. This makes it possible to allow articles 9 to be transported to the carry-out section 7 in an order different from the order in which the articles 9 are received from the holding sections 50, while also suppressing the case where an article 9 transported to a holding section 50 remains in the holding section 50 for too long.

In the present embodiment, each of the temporary storage sections 6 includes a presence sensor 60D (see FIG. 3) that detects the presence or absence of an article 9. As described later, information on the presence or absence of an article 9 in the temporary storage section 6 detected by the presence sensor 60D is transmitted to the control system 8.

The temporary storage sections 6 include a plurality of dual-zone temporary storage sections 6m arranged in a line along both the first zone 21 and the second zone 22 at positions between the first zone 21 and the second zone 22 in the specific direction X. In the present embodiment, the dual-zone temporary storage sections 6m are arranged in a line in the up-down direction at positions between the first zone 21 and the second zone 22 in the specific direction X.

Each of the dual-zone temporary storage sections 6m can transport an article 9 along the specific direction X. Accordingly, each of the dual-zone temporary storage sections 6m can receive an article 9 from a transport cart 1 in the first zone 21 and pass the article 9 to a transport cart 1 in the second zone 22. For example, each of the dual-zone temporary storage sections 6m includes a conveyor that transports an article 9 along the specific direction X.

In the present embodiment, the temporary storage sections 6 further include single-side temporary storage sections 6s that are arranged in a line along the second zone 22 and can transfer articles 9 only to and from transport carts 1 located in the second zone 22. In the present embodiment, the single-side temporary storage sections 6s are arranged on the side of the second zone 22 opposite to the dual-zone temporary storage sections 6m in the specific direction X. In other words, the dual-zone temporary storage sections 6m are arranged adjacent to one side of the second zone 22 in the specific direction X. The single-side temporary storage sections 6s are arranged adjacent to the other side of the second zone 22 in the specific direction X.

In the present embodiment, a plurality of single-side temporary storage sections 6s are arranged along the transport path 2. In this example, the single-side temporary storage sections 6s are arranged in a line in the up-down direction.

Each of the single-side temporary storage sections 6s can transport an article 9 along the specific direction X. Accordingly, the single-side temporary storage sections 6s can transfer articles 9 to and from a transport cart 1 in the second zone 22. For example, each of the single-side temporary storage sections 6s includes a conveyor that transports an article 9 along the specific direction X.

The transport carts 1 can transfer articles 9 to and from the holding sections 50, the temporary storage sections 6, and the carry-out section 7 at corresponding positions on the transport path 2. In other words, the holding sections 50, the temporary storage sections 6, and the carry-out section 7 are transfer target locations at which the articles 9 can be transferred to or from the transport carts 1.

In this transport facility 100, the transport cart 1 can transport an article 9 held by any holding section 50 among the holding sections 50 to the carry-out section 7. For example, while moving from a holding section 50 to the carry-out section 7, the transport cart 1 transports an article 9 to one of the temporary storage sections 6 (a dual-zone temporary storage section 6m or a single-side temporary storage section 6s).

As shown in FIG. 2, in the present embodiment, each of the transport carts 1 includes a body section 10, a transfer section 11 for transferring the articles 9 between the above-mentioned transfer target locations, drive wheels 12 each having a wheel gear section 12g that meshes with the rail gear sections 30 of the pair of drive rails 3, first auxiliary wheels 13 guided by the pair of auxiliary rails 4, and second auxiliary wheels 14 guided by the pair of auxiliary rails 4.

The transfer section 11 can transfer an article 9 along the specific direction X. Accordingly, the transfer section 11 can transfer the article 9 to or from a transfer target location arranged adjacent to the transport cart 1 in the specific direction X. In this example, the transfer section 11 is configured using a conveyor. However, the transfer section 11 may be configured using a known transfer section provided with a fork mechanism, a chuck mechanism, or the like.

The pair of drive wheels 12 are connected to a drive shaft 12a that protrudes outward in the orthogonal direction Y from the body section 10. The drive wheels 12 can rotate about an axis extending in the orthogonal direction Y. The drive shaft 12a is rotated by a drive source (not shown) such as a motor.

In the present embodiment, the pair of first auxiliary wheels 13 and the pair of second auxiliary wheels 14 are non-driven wheels supported so as to be capable of rotating relative to the body section 10. The first auxiliary wheels 13 and the second auxiliary wheels 14 can rotate around an axis extending in the orthogonal direction Y. The first auxiliary wheels 13 and the second auxiliary wheels 14 are disposed between the pair of guide surfaces 40 provided on the auxiliary rails 4, and rotate by coming into contact with the guide surfaces 40. As described above, the pair of first auxiliary wheels 13 and the pair of second auxiliary wheels 14 are non-driven wheels, and thus the number of drive sources provided in the transport cart 1 can be kept small. Therefore, it is possible to reduce the cost of the transport cart 1.

In the present embodiment, the pair of drive wheels 12, the pair of first auxiliary wheels 13, and the pair of second auxiliary wheels 14 are disposed at different positions in the up-down direction. Specifically, these three pairs of wheels are supported by the drive rails 3 or the auxiliary rails 4 at different positions in the up-down direction on opposite sides of the transport cart 1 in the orthogonal direction Y. This makes it easier to suppress tilting of the transport cart 1 in the up-down direction.

In the present embodiment, the first auxiliary wheel 13 and the second auxiliary wheel 14 are disposed at positions spaced apart from each other in the up-down direction and spaced apart from the drive wheel 12 in the specific direction X. The drive wheel 12 is disposed between the first auxiliary wheel 13 and the second auxiliary wheel 14 in the up-down direction. As a result, a moment of force for tilting of the transport cart 1 in the up-down direction can be stopped by the first auxiliary wheel 13 and the second auxiliary wheel 14 coming into contact with the guide surfaces 40. Therefore, it is possible to avoid the case where a load is applied to the drive wheel 12 due to tilting of the transport cart 1. Therefore, it is easy to suppress tilting of the transport cart 1 while also appropriately applying propulsive force for moving the transport cart 1 along the transport path 2.

As shown in FIG. 3, the transport facility 100 includes a central control device 80 that performs overall control of the facility, and transport control devices 81 respectively mounted to the transport carts 1. In the present embodiment, the central control device 80 and the transport control devices 81 configure at least a part of the control system 8. The control system 8 (in the present embodiment, the central control device 80 and the transport control devices 81) includes, for example, a processor such as a microcomputer, peripheral circuits such as a memory, and the like. Various functions are realized by cooperation between such hardware and a program executed on the processor of the computer or the like.

In the present embodiment, each of the transport carts 1 includes a position detector 15 that detects the current position of the transport cart. In this example, as shown in FIG. 1, detection targets 25 are provided at positions corresponding to transfer target locations such as the holding sections 50, the temporary storage sections 6, and the carry-out section 7. Each of the detection targets 25 holds address information on the position where the detection target 25 is located. The transport cart 1 can detect its current position by reading the address information stored in a detection target portion 25 with the position detector 15. For example, a one-dimensional code or a two-dimensional code may be used as the detection target 25, and a one-dimensional code reader or a two-dimensional code reader may be used as the position detector 15.

In the present embodiment, the detection targets 25 are provided on the transport path 2. Specifically, the detection targets 25 are provided at positions adjacent to the upstream sides of transfer target locations on the transport path 2, such as the holding sections 50, the temporary storage sections 6, and the carry-out section 7. Accordingly, the transport cart 1 can determine its current location before arriving at the intended transfer target location. Therefore, the transport cart 1 can perform arrival preparation, such as slowing down, before arriving at the intended transfer target location.

Information on the current position of the transport cart 1 acquired by the position detector 15 is transmitted to the central control device 80 via the transport control device 81. Therefore, the central control device 80 can determine the current position of each of the transport carts 1 on the transport path 2.

As shown in FIG. 3, in the present embodiment, each of the holding sections 50 includes the presence sensor 50D that detects the presence or absence of an article 9. Information on the presence or absence of an article 9 in the holding section 50 detected by the presence sensor 50D is transmitted to the central control device 80. Therefore, the central control device 80 is able to determine the presence or absence of the articles 9 in the holding sections 50.

In the present embodiment, each of the temporary storage sections 6 includes the presence sensor 60D that detects the presence or absence of an article 9. Information on the presence or absence of an article 9 in the temporary storage section 6 detected by the article presence sensor 60D is transmitted to the central control device 80. Therefore, the central control device 80 is able to determine the presence or absence of the articles 9 in the temporary storage sections 6.

The control system 8 controls a transport cart 1 to transport an article 9 held in any holding section 50 among the holding sections 50 to the carry-out section 7 based on information acquired from the presence sensors 50D provided in the holding sections 50.

Also, the control system 8 controls a transport cart 1 to transport an article 9 to any of the temporary storage sections 6 while the transport cart 1 moves from a holding section 50 to the carry-out section 7, based on information acquired from the presence sensors 60D provided in the temporary storage sections 6 (the dual-zone temporary storage sections 6m and the single-side temporary storage sections 6s).

As shown in FIG. 1, the control system 8 assigns an article 9 to be transported to the carry-out section 7 to each of the transport carts 1. In the example shown in FIG. 1, the letters A, B, C . . . denoting articles 9 correspond to the letters A, B, C . . . denoting transport carts 1. For example, the article 9(D) corresponds to the transport cart 1(D). In other words, an article 9(D) is assigned to the transport cart 1(D) by the control system 8. In this case, the transport cart 1(D) transports the article 9(D) from the corresponding holding section 50 to the carry-out section 7. Note that the letters A, B, C . . . denoting the articles 9 and the transport carts 1 in FIG. 1 do not actually exist. Such letters are illustrated here for ease of description.

In this specification, one of the articles 9 held in the holding sections 50 will be referred to as the target article 9, articles 9 other than the target article 9 among the articles 9 held in the holding sections 50 will be referred to as non-target articles 9, and the holding section 50 in which the target article 9 is held will be referred to as the target holding section 50. Each of the transport carts 1 can be designated as a target transport cart 1, and the control system 8 assigns the target article 9 to one of the target transport carts 1. In the example shown in FIG. 1, when attention is focused on the transport cart 1(D), the article 9(D) assigned to the transport cart 1(D) is the target article 9. The holding section 50 in which the article 9(D) is held is the target holding section 50. In other words, the target article 9, the non-target articles 9, and the target holding section 50 are concepts that change depending on which of the transport carts 1 is designated as the target transport cart 1.

In the present embodiment, the control system 8 designates the target article 9 to be transported by the target transport cart 1 at a time that is after the target transport cart 1 has passed the transported article 9 to the carry-out section 7 and before the target transport cart 1 arrives at the holding section 50 at the most upstream location. In the example shown in FIG. 1, after the target transport cart 1 has passed the article 9(V) to the carry-out section 7, the target article 9(H) to be transported next is designated by the control system 8. Thereafter, the target transport cart 1(H) travels around the transport path 2 in order to receive the article 9(H) from the target holding section 50 and transport the received article to the carry-out section 7.

The control system 8 can execute relay carry-out processing or direct carry-out processing as processing for transporting the target article 9 from the target holding section 50 to the carry-out section 7.

### Relay Carry-Out Processing

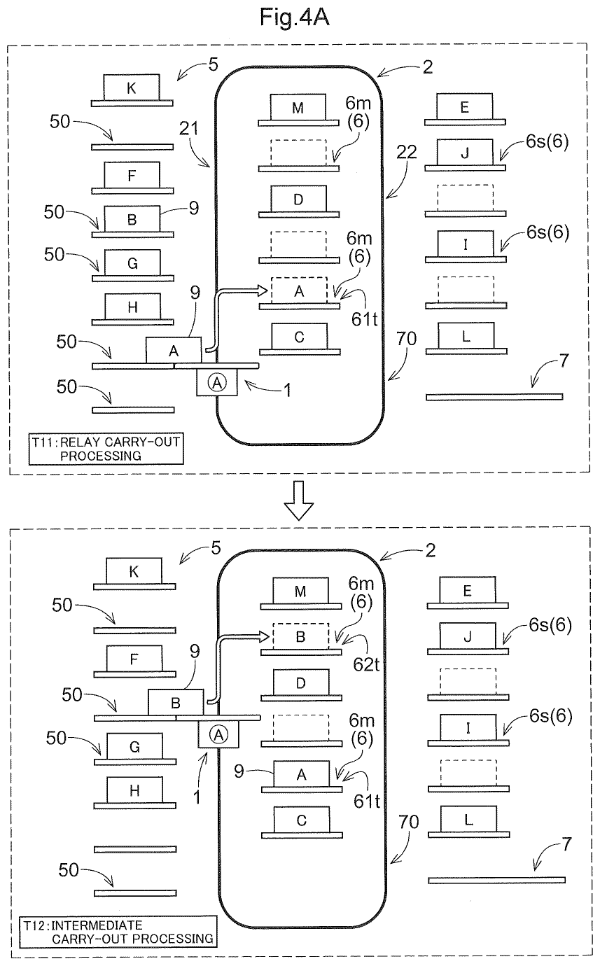

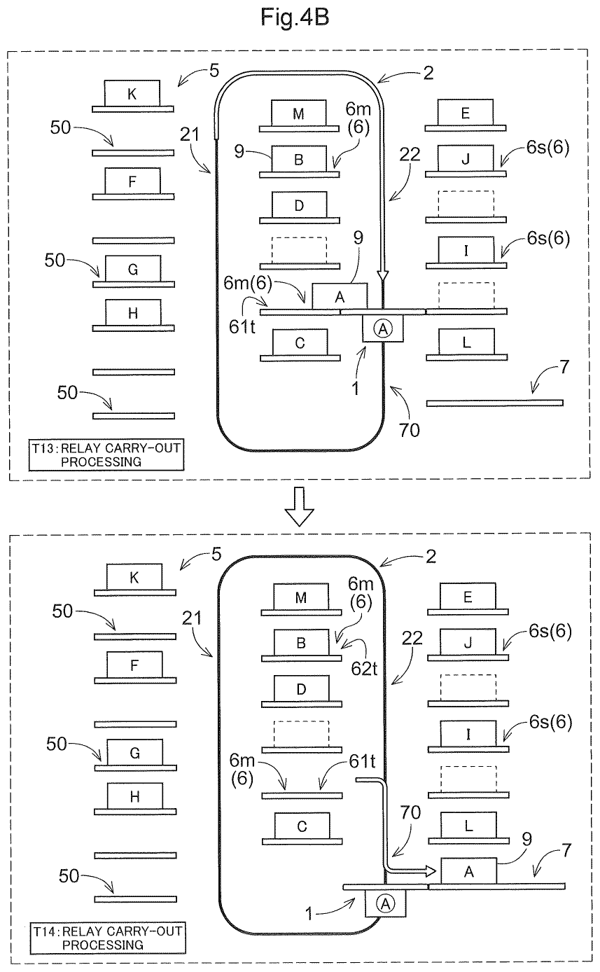

In the case where a relay carry-out condition is satisfied, the control system 8 executes relay carry-out processing using a transport cart 1. The relay carry-out condition is that in the case where the transport cart 1 transports the target article 9 to the carry-out section 7, there is an empty dual-zone temporary storage section 6m downstream of the target holding section 50 in the first zone 21. Note that the downstream side of a target or a target position is a concept that includes both a reference position (the placement position of the target or the target position) and a position spaced downstream from the reference position. Here, the target holding section 50 is the target, and the placement position of the target holding section 50 is the reference position. In the case where this relay carry-out condition is met, under control of the control system 8, the empty dual-zone temporary storage section 6m is designated as a first target temporary storage section 61t (see FIG. 4A and the like), the target article 9 is received from the target holding section 50 and passed to the first target temporary storage section 61t in the first zone 21, and then the target article 9 is received from the first target temporary storage section 61t and passed to the carry-out section 7 in the second zone 22.

### Direct Carry-Out Processing

In the case where a direct carry-out condition is satisfied, the control system 8 executes direct carry-out processing using a transport cart 1. The direct carry-out condition is that in the case where the transport cart 1 transports the target article 9 from the target holding section 50 to the carry-out section 7, there is no empty dual-zone temporary storage section 6m downstream of the target holding section 50 in the first zone 21. In the case where the direct carry-out condition is met, under control of the control system 8, the target article 9 is received from the target holding section 50, the target article 9 is transported directly to the carry-out position 70, and the target article 9 is passed to the carry-out section 7.

The control system 8 can execute either intermediate transport processing or preliminary transport processing as processing for transporting a non-target article 9 from a holding section 50 to a temporary storage section 6.

### Intermediate Transport Processing

In the case where an intermediate transport condition is satisfied, the control system 8 executes intermediate transport processing using a transport cart 1. The intermediate transport condition is that, in the case where the above-mentioned relay carry-out processing is executed, there is a non-target holding section 50, which is a holding section 50 in which a non-target article 9 is held, downstream of the position where the target article 9 was passed to the first target temporary storage section 61t in the first zone 21, and there is an empty temporary storage section 6 at a position that is downstream of the non-target holding section 50 and upstream of the position where the target article 9 is to be received from the first target temporary storage section 61t in the second zone 22. Note that the upstream side of a target article or a target position is a concept that includes both a reference position (the placement position of the target or the target position) and a position spaced upstream from the reference position. In the case where this intermediate transport condition is satisfied, under control of the control system 8, an empty temporary storage section 6 is designated as a second target temporary storage section 62t (see FIG. 4A and the like), and during the relay carry-out processing, the non-target article 9 is received from the non-target holding section 50 and passed to the second target temporary storage section 62t. Note that in the intermediate transport processing, a dual-zone temporary storage section 6m or a single-side temporary storage section 6s may be set as the second target temporary storage section 62t, and the non-target article 9 may be passed to that second target temporary storage section 62t.

### Preliminary Transport Processing

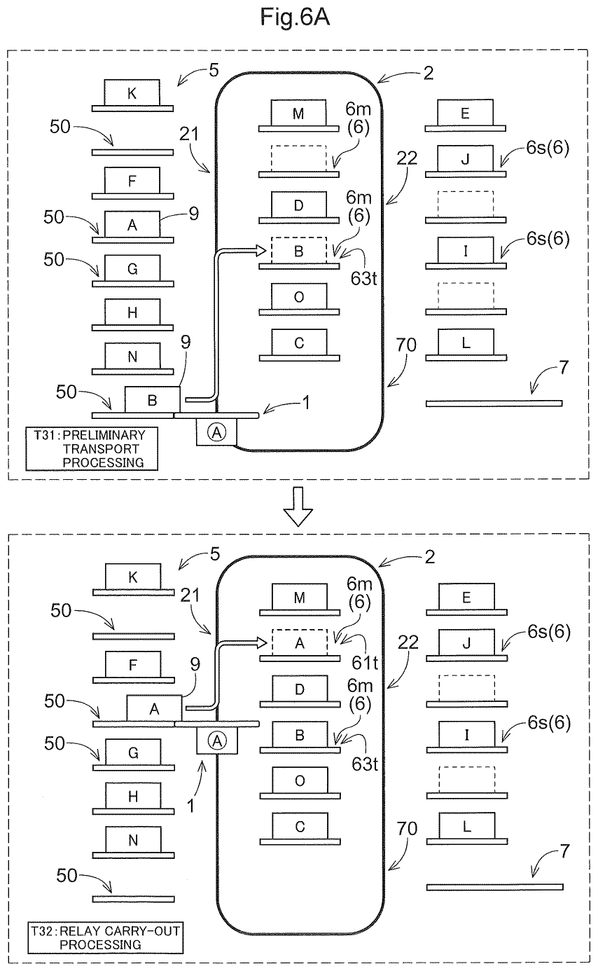

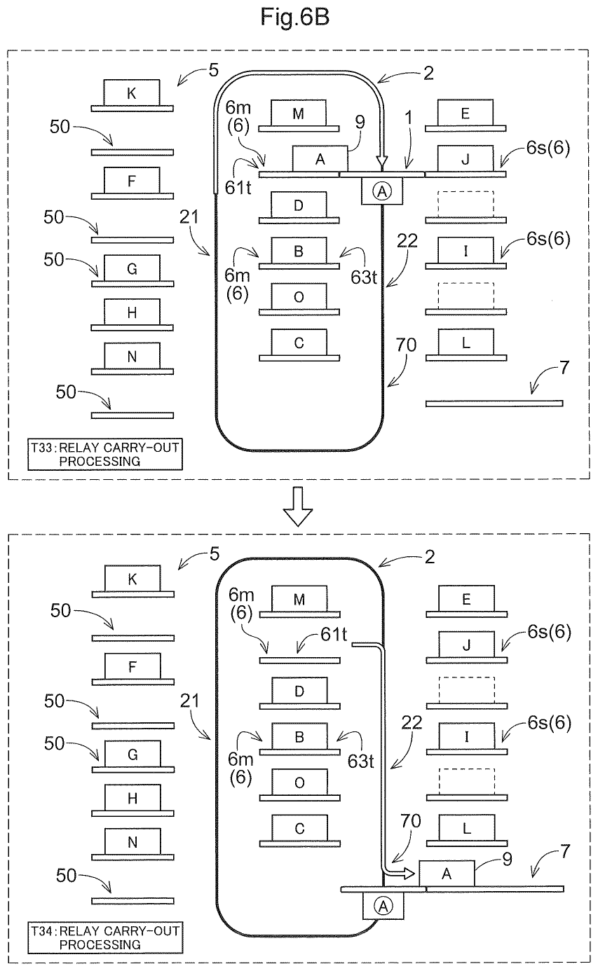

In the case where a preliminary transport condition is satisfied, the control system 8 executes preliminary transport processing using a transport cart 1. The preliminary transport condition is that a non-target holding section 50 is present upstream of the target holding section 50 in the first zone 21, and furthermore an empty temporary storage section 6 is present at a position that is downstream of the non-target holding section 50 and upstream of the target holding section 50. In the case where this preliminary transport condition is satisfied, under control of the control system 8, an empty temporary storage section 6 is designated as a third target temporary storage section 63t (see FIG. 6A), and before the target article 9 is received from the target holding section 50, the non-target article 9 is received from the non-target holding section 50 and passed to the third target temporary storage section 63t. Note that in the preliminary transport processing, a dual-zone temporary storage section 6m among the temporary storage sections 6 is set as the third target temporary storage sections 63t, and the non-target article 9 is passed to that third target temporary storage section 63t. As described above, in the preliminary transport processing, a non target article 9 needs to be passed to a temporary storage section 6 before the transport cart 1 receives the target article 9 from the target holding section 50, and therefore none of the single-side temporary storage sections 6s located downstream of the holding devices 5 (all holding sections 50) can be set as the third target temporary storage section 63t.

In the present embodiment, in the case where there are a plurality of non-target holding sections 50, each time the transport cart 1 arrives at any of the non-target holding sections, the control system 8 determines presence or absence of an empty temporary storage section 6 that could receive the non-target article 9 held by the non-target holding section 50 at which the transport cart 1 arrived. This makes it possible to determine whether or not to transport a non-target article 9 depending on the states of the temporary storage sections 6 at the time when the transport cart 1 is able to receive the non-target article 9 from a non-target holding section 50.

Next, processing performed by the control system 8 in different cases will be described with reference to FIGS. 4 to 6. Note that in FIGS. 4 to 6, articles 9 that actually exists are shown by solid lines, and dashed lines show the shape of articles 9 on empty temporary storage sections 6 to which an article 9 can be transferred.

### Case 1

FIGS. 4A and 4B show processing executed by the control system 8 in Case 1. Case 1 is a case in which the control system 8 executes relay carry-out processing and intermediate transport processing.

As shown in FIG. 4A, at a time T11, in the first zone 21, an empty dual-zone temporary storage section 6m is present downstream of the target holding section 50 in which the target article 9(A) is held. Therefore, the relay carry-out condition is satisfied. The control system 8 starts the relay carry-out processing, sets the empty dual-zone temporary storage section 6m as the first target temporary storage section 61t, receives the target article 9(A) from the target holding section 50 and passes the received article to the first target temporary storage section 61t in the first zone 21. As shown in FIG. 4A, in the present embodiment, when the control system 8 executes the relay carry-out processing, if there are a plurality of empty dual-zone temporary storage sections 6m downstream of the target holding section 50 in the first zone 21, the control system 8 sets the most upstream dual-zone temporary storage section 6m among them as the first target temporary storage section 61t. Accordingly, the position at which the transport cart 1(A) passes the target article 9(A) to the temporary storage section 6 can be located further upstream. This makes it possible to secure a wider range of the transport path 2 in which the transport cart 1(A), which continues to move along the transport path 2 thereafter, can transport the non-target article 9.

At a time T12 (a time after the time T11), downstream of the position where the target article 9(A) was passed to the first target temporary storage section 61t in the first zone 21, there is a non-target holding section 50 (the holding section 50 at the fourth level from the top) in which a non-target article 9(B) is held, for example, and at a position downstream of the non-target holding section 50 and upstream of the position where the target article 9(A) is to be received from the first target temporary storage section 61t in the second zone 22, there is an empty temporary storage section 6 (e.g., a dual-zone temporary storage section 6m). Therefore, the intermediate transport condition is satisfied. The control system 8 executes intermediate transport processing, sets the above-mentioned empty temporary storage section 6 (dual-zone temporary storage section 6m) as the second target temporary storage section 62t, and, during the relay carry-out processing, receives the non-target article 9(B) from the non-target holding section 50 and passes the received article to the second target temporary storage section 62t. Note that in the intermediate transport processing, the control system 8 selects the second target temporary storage section 62t from among both the dual-zone temporary storage sections 6m and the single-side temporary storage sections 6s. Therefore, if there is an empty single-side temporary storage section 6s that can satisfy the intermediate transport condition, the control system 8 may select that single-side temporary storage section 6s as the second target temporary storage section 62t instead of the empty dual-zone temporary storage section 6m.

As shown in FIG. 4B, at a time T13 (a time after the time T12), the control system 8 resumes the relay carry-out processing and receives the target article 9(A) from the first target temporary storage section 61t in the second zone 22. Then, at a time T14 (a time after the time T13), the control system 8 passes the target article 9(A) received from the first target temporary storage section 61t in the second zone 22 to the carry-out section 7.

In this way, by executing the relay carry-out processing, the control system 8 can temporarily place the target article 9(A) in a temporary storage section 6 that is closer to the carry-out section 7 than the target holding section 50. Then, after passing the target article 9(A) to the temporary storage section 6, while moving without transporting the target article 9(A), the transport cart 1(A) can receive the non-target article 9(B) from the non-target holding section 50 and pass it to another temporary storage section 6. Thereafter, the transport cart 1(A) can receive the target article 9(A) that it passed to the temporary storage section 6 in the second zone 22 and appropriately pass it to the carry-out section 7. In the above, the non-target article 9(B) placed in the other temporary storage section 6 can become the target article 9 for another transport cart 1, thus making it possible to shorten the transport distance when the other transport cart 1 transports the non-target article 9(B) to the carry-out section 7.

### Case 2

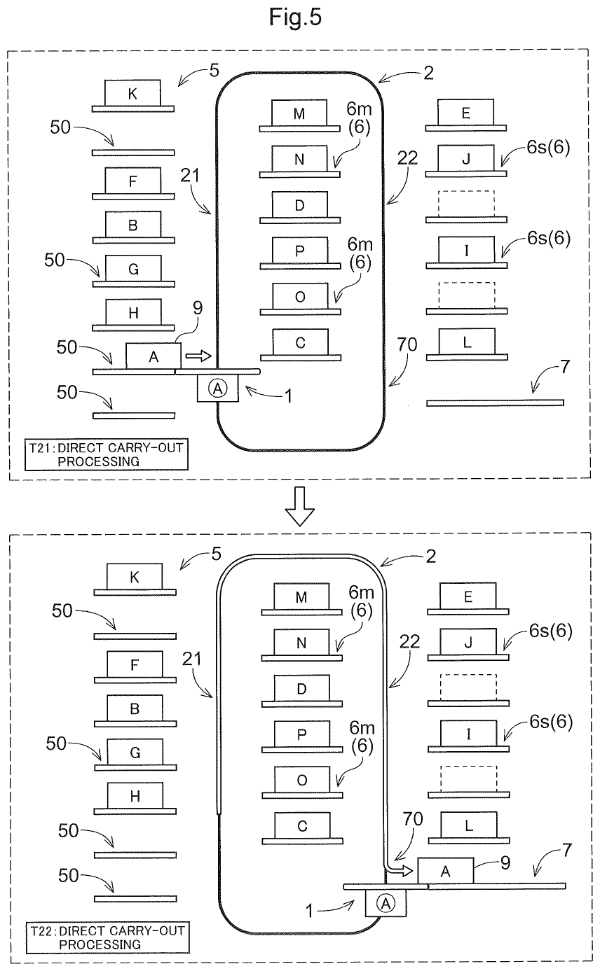

FIG. 5 shows processing executed by the control system 8 in Case 2. Case 2 is a case in which the control system 8 executes direct carry-out processing.

As shown in FIG. 5, at a time T21, in the first zone 21, there is no empty dual-zone temporary storage section 6m downstream of the target holding section 50 in which the target article (A) is held. Therefore, the direct carry-out condition is satisfied. The control system 8 executes direct carry-out processing, receives the target article 9(A) from the target holding section 50 (time T21), transports the target article 9(A) directly to the carry-out position 70, and passes the target article 9(A) to the carry-out section 7 (time T22).

In this way, in a situation where there is no empty dual-zone temporary storage section 6m downstream of the target holding section 50 in the first zone 21, by executing direct carry-out processing, the control system 8 can appropriately transport the target article 9(A) from the target holding section 50 to the carry-out section 7 without transporting a non-target article 9.

### Case 3

FIGS. 6A and 6B show processing executed by the control system 8 in Case 3. Case 3 is a case in which the control system 8 executes preliminary transport processing and relay carry-out processing.

As shown in FIG. 6A, at a time T31, upstream of the target holding section 50 in which the target article 9(A) is held in the first zone 21, there is a non-target holding section 50 in which the non-target article 9(B) is held, and at a position that is downstream of the non-target holding section 50 and upstream of the target holding section 50, there is an empty dual-zone temporary storage section 6m (the dual-zone temporary storage section 6m at the fourth level from the top). Therefore, the preliminary transport condition is satisfied. The control system 8 executes preliminary transport processing, sets the empty dual-zone temporary storage section 6m as the third target temporary storage section 63t, and before receiving the target article 9(A) from the target holding section 50, receives the non-target article 9(B) from the non-target holding section 50 and passes the received article to the third target temporary storage section 63t.

At a time T32 (a time after the time T31), an empty dual-zone temporary storage section 6m (the dual-zone temporary storage section 6m at the second level from the top) is present downstream of the target holding section 50 in which the target article 9(A) is held in the first zone 21. Therefore, the relay carry-out condition is satisfied. The control system 8 starts the relay carry-out processing, sets the empty dual-zone temporary storage section 6m as the first target temporary storage section 61t, receives the target article 9(A) from the target holding section 50 and passes the received article to the first target temporary storage section 61t in the first zone 21.

As shown in FIG. 6B, at a time T33 (a time after the time T32), downstream of the position where the target article 9(A) was passed to the first target temporary storage section 61t in the first zone 21, there is a non-target holding section 50 (the highest holding section 50) in which a non-target article 9(K) is held, but there is no empty temporary storage section 6 at a position that is downstream of the non-target holding section 50 and upstream of the position where the target article 9(A) is to be received from the first target temporary storage section 61t (dual-zone temporary storage section 6m at the second level from the top) in the second zone 22. Therefore, the intermediate transport condition is not satisfied, and the control system 8 does not execute intermediate transport processing. Therefore, without receiving the non-target article 9 downstream of the position where the target article 9(A) was passed to the first target temporary storage section 61t in the first zone 21, the control system 8 receives the target article 9(A) from the first target temporary storage section 61t in the second zone 22. Then, at a time T34 (a time after the time T33), the control system 8 passes the target article 9(A) received from the first target temporary storage section 61t in the second zone 22 to the carry-out section 7. Note that in the case where the intermediate transport condition is satisfied above, the control system 8 may execute intermediate transport processing before receiving the target article 9(A) from the first target temporary storage section 61t in the second zone 22.

In this way, by executing preliminary transport processing, the control system 8 can move the non-target article 9(B) to a position closer to the carry-out section 7 while the transport cart 1(A) is moving but has not yet arrived at the target holding section 50.

### Temporary Storage Section Reservation Processing

In the present embodiment, the control system 8 can execute temporary storage section reservation processing. In temporary storage section reservation processing, a specific temporary storage section 6 that is in an empty state is reserved for the placement of an article when the transport cart 1 is located upstream of that temporary storage section 6. Even though the reserved temporary storage section 6 is actually empty, other transport carts 1 treat that storage section as if an article 9 is held therein.

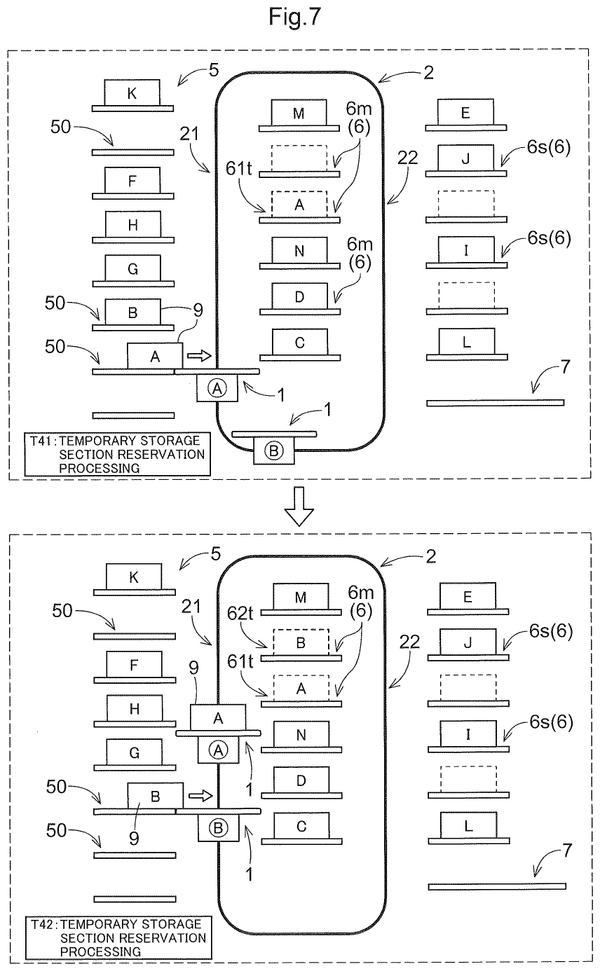

FIG. 7 shows a case where the control system 8 executes temporary storage section reservation processing. In the example shown in FIG. 7, two transport carts 1 are moving along the transport path 2. Out of the two vehicles, the target article 9(A) is assigned to the transport cart 1(A), which moves first (downstream). Out of the two vehicles, the target article 9(B) is assigned to the transport cart 1(B), which moves at a later time (upstream). In the following, the transport cart 1(A) will be referred to as the leading transport cart 1(A), and the transport cart 1(B) will be referred to as the trailing transport cart 1(B).

As shown in FIG. 7, at a time T41, when the leading transport cart 1(A) receives the target article 9(A) from the target holding section 50, there are two empty dual-zone temporary storage sections 6m (the dual-zone temporary storage sections 6m at the second and third levels from the top). By executing the temporary storage section reservation processing, the control system 8 reserves one of the two empty dual-zone temporary storage sections 6m (the dual-zone temporary storage section 6m at the third level from the top) as the temporary storage section 6 in which the leading transport cart 1(A) is to place the target article 9(A).

At a time T42 (a time after the time T41), when the trailing transport cart 1(B) receives the target article 9(B) from the target holding section 50, the leading transport cart 1(A) has not yet placed the target article (A) in the reserved dual-zone temporary storage section 6m (the dual-zone temporary storage section 6m at the third level from the top), and therefore there are actually two empty dual-zone temporary storage sections 6m (the dual-zone temporary storage sections 6m at the second and third levels from the top). However, the dual-zone temporary storage section 6m (the dual-zone temporary storage section 6m at the third level from the top) that was reserved as the temporary storage section 6 in which the leading transport cart 1(A) is to place the target article 9(A) is treated by the trailing transport cart 1(B) as a storage section in which the target article 9(A) is placed. Therefore, the control system 8 executes temporary storage section reservation processing again such that an empty dual-zone temporary storage section 6m (the dual-zone temporary storage section 6m at the second level from the top) other than the dual-zone temporary storage section 6m reserved as the temporary storage section 6 in which the leading transport cart 1(A) is to place the target article 9(A), is reserved as the temporary storage section 6 in which the trailing transport cart 1(B) is to place the target article 9(B).

In this way, by executing the temporary storage section reservation processing, the control system 8 can avoid a situation in which a plurality of transport carts 1 moving along the transport path 2 have received articles 9 from holding sections 50 but are unable to transport the articles 9 to a temporary storage section 6.

### Group Retrieval Processing

In the present embodiment, the control system 8 can execute group retrieval processing. The group retrieval processing includes processing for deeming at least one of the articles 9 stored in the temporary storage sections 6 to be a target article 9, and selecting a target article to be transported to the carry-out section 7 from among the articles 9 deemed to be a target article 9. The control system 8 executes group retrieval processing, relay carry-out processing, and intermediate transport processing. In other words, the control system 8 sets, as an equivalent article 9, at least one of the articles 9 that are stored in the temporary storage sections 6 and can be deemed to be equivalent to a target article 9. Then, if intermediate transport processing can be executed with an equivalent article 9 being deemed to be a target article 9 and the temporary storage section 6 holding the equivalent article 9 being deemed to be the first target temporary storage section 61t, the equivalent article 9 is deemed to be the target article 9 and the temporary storage section 6 holding the equivalent article 9 is deemed to be the first target temporary storage section 61t, and the relay carry-out processing and intermediate transport processing are executed. For example, an article 9 that contains the same product as the target article 9 may be set as an equivalent article 9. Also, in the case where a plurality of articles 9 (e.g., a plurality of articles 9 designated by one piece of order information) are to be transported to the carry-out section 7 as a single group, the articles 9 included in the same group as the target article 9 can be set as equivalent articles 9.

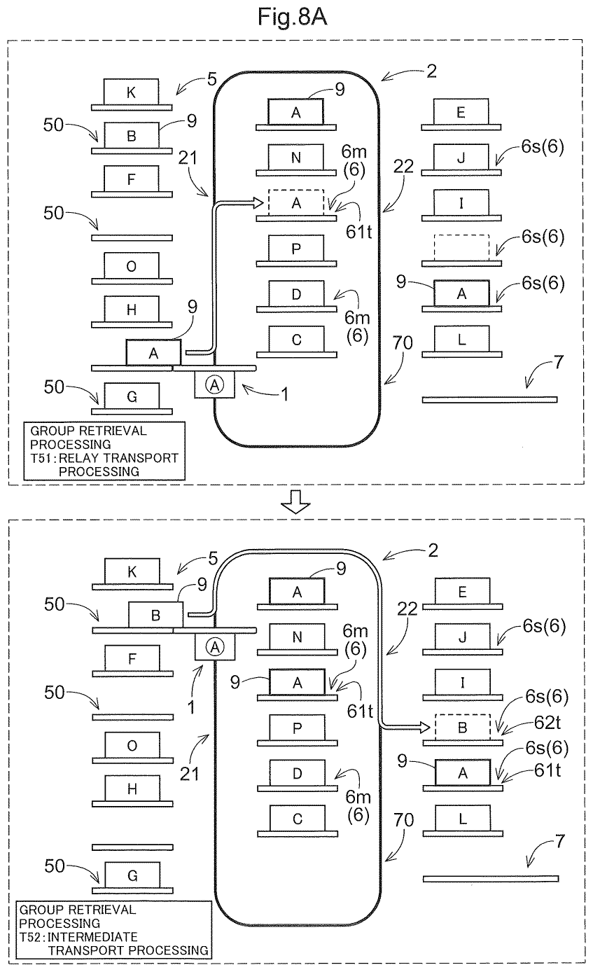

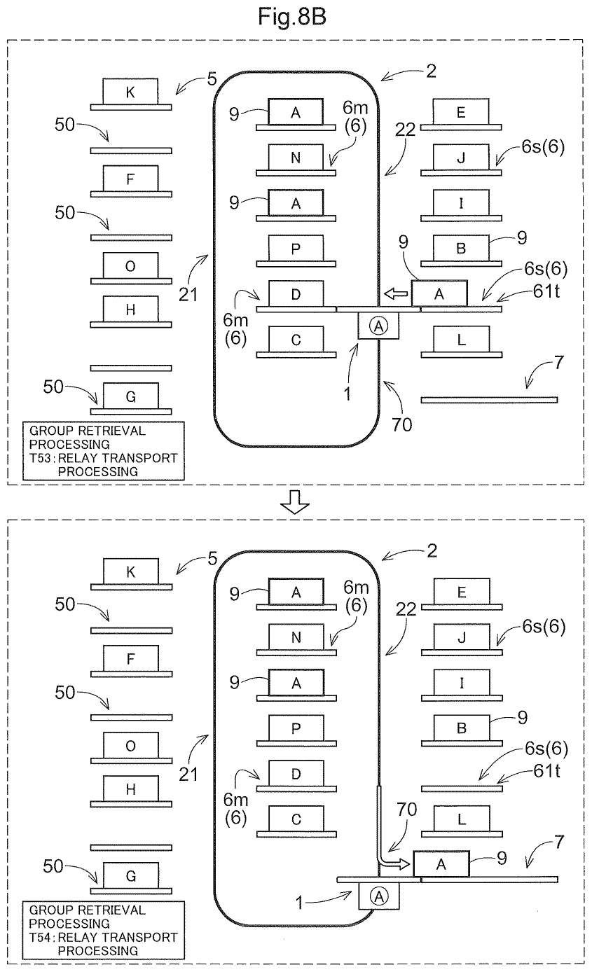

FIGS. 8A and 8B show a case in which the control system 8 executes group retrieval processing as well as relay carry-out processing and intermediate transport processing. In the example shown in FIGS. 8A and 8B, the article 9(A) placed in one dual-zone temporary storage section 6m (the dual-zone temporary storage section 6m at the top level) and the article 9(A) placed in one single-side temporary storage section 6s (the single-side temporary storage section 6s at the fifth level from the top) are deemed to be equivalent to the target article (A) to be transported by the transport cart 1(A).

As shown in FIG. 8A, at a time T51, in the first zone 21, an empty dual-zone temporary storage section 6m (the dual-zone temporary storage section 6m at the third level from the top) is present downstream of the target holding section 50 in which the target article 9(A) is held. Therefore, the relay carry-out condition is satisfied. The control system 8 starts the relay carry-out processing, sets the empty dual-zone temporary storage section 6m as the first target temporary storage section 61t, receives the target article 9(A) from the target holding section 50 and passes the received article to the first target temporary storage section 61t in the first zone 21.

At a time T52 (a time after the time T51), downstream of the position where the target article 9(A) was passed to the first target temporary storage section 61t in the first zone 21, there is a non-target holding section 50 (the holding section 50 second from the top) in which the non-target article 9(B) is held, for example, but at a position that is downstream of the non-target holding section 50 and upstream of the first target temporary storage section 61t (the dual-zone temporary storage section 6m at the third level from the top) where the target article 9(A) was passed earlier in the second zone 22, there is no empty temporary storage section 6. However, in this case, the article 9(A) already placed in the single-side temporary storage section 6s (the single-side temporary storage section 6s at the fifth level from the top) located downstream of the empty single-side temporary storage section 6s (the single-side temporary storage section 6s at the fourth level from the top) is deemed to be equivalent to the target article 9(A) to be transported by the transport cart 1(A), and the single-side temporary storage section 6s where the article 9(A) is placed is deemed to be the first target temporary storage section 61t. Therefore, an empty single-side temporary storage section 6s (the single-side temporary storage section 6s at the fourth level from the top) is present at a position that is downstream of the non-target holding section 50 (the holding section 50 at the second level from the top) in which the non-target article 9(B) is held and upstream of the position where the target article 9(A) is to be received from the first target temporary storage section 61t in the second zone 22 (i.e. upstream of the single-side temporary storage section 6s at the fifth level from the top). Therefore, the intermediate transport condition is satisfied. The control system 8 executes intermediate transport processing, sets the empty single-side temporary storage section 6s as the second target temporary storage section 62t, and, during the relay carry-out processing, receives the non-target article 9(B) from the non-target holding section 50 and passes the received article to the second target temporary storage section 62t.

As shown in FIG. 8B, at a time T53 (a time after the time T52), the control system 8 resumes the relay carry-out processing and receives the equivalent article 9(A), which has been deemed to be the target article 9(A), from the single-side temporary storage section 6s (the single-side temporary storage section 6s at the fifth level from the top) which has been deemed to be the first target temporary storage section 61t in the second zone 22. Then, at a time T54 (a time after the time T53), the control system 8 passes, to the carry-out section 7, the equivalent article 9(A) that was deemed to be the target article 9(A) and received.

In this way, by executing group retrieval processing, the control system 8 can increase the number of options available when transporting articles 9 to the carry-out section 7 or the temporary storage sections 6, thereby increasing the possibility of being able to execute relay carry-out processing and intermediate transport processing.

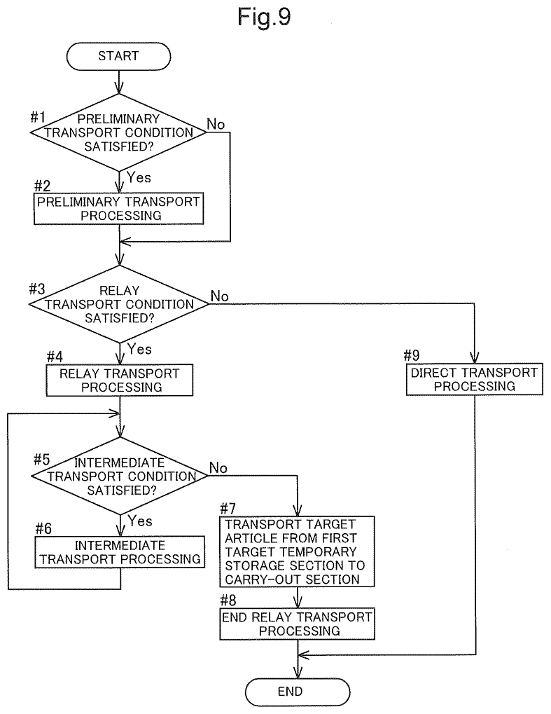

Next, the procedure of the processing executed by the control system 8 will be described with reference to the flowchart of FIG. 9. Note that the processing shown in the flowchart of FIG. 9 is executed with respect to one transport cart 1. The control system 8 executes this processing for each of the transport carts 1 moving on the transport path 2.

As shown in FIG. 9, the control system 8 first determines whether or not the preliminary transport condition is satisfied (step #1). In the case of determining that the preliminary transport condition is satisfied (step #1: Yes), the control system 8 executes preliminary transport processing (step #2). Next, the control system 8 determines whether or not the relay carry-out condition is satisfied (step #3). Note that in the case of determining that the preliminary transport condition is not satisfied in the processing of step #1 (step #1: No), the control system 8 proceeds to the processing of step #3 without executing preliminary transport processing.

In the case of determining that the relay carry-out condition is satisfied (step #3: Yes), the control system 8 starts the relay carry-out processing (step #4). The control system 8 starts the relay carry-out processing, receives the target article 9 from the target holding section 50, and passes the received article to the first target temporary storage section 61t. Note that in the case of determining that the relay carry-out condition is not satisfied (step #3: No), the control system 8 executes direct carry-out processing (step #9) and ends the routine.

After starting the relay carry-out processing (step #4), the control system 8 determines whether or not the intermediate transport condition is satisfied (step #5). In the case of determining that the intermediate transport condition is satisfied (step #5: Yes), the control system 8 executes intermediate transport processing (step #6). The control system 8 repeatedly executes the processing of step #5 and the processing of step #6 until it is determined that the intermediate transport condition is not satisfied.

In the case of determining that the intermediate transport condition is not satisfied (step #5: No), the control system 8 resumes the relay carry-out processing and transports the target article 9 in the first target temporary storage section 61t to the carry-out section 7 (step #7), and then ends the relay carry-out processing (step #8).

According to the transport facility 100 described above, it is possible to improve the overall transport efficiency when transporting articles 9 to the carry-out section 7 in the facility.

### Other Embodiments

Next, other embodiments of the transport facility will be described.
(1) In the above embodiment, an example is described in which in the case where the control system 8 executes the relay carry-out processing, if there are a plurality of empty dual-zone temporary storage sections 6m downstream of the target holding section 50 in the first zone 21, the control system 8 sets the most upstream dual-zone temporary storage section 6m as the first target temporary storage section 61t. However, the present invention is not limited to such an example, and the control system 8 may set any one of the empty dual-zone temporary storage sections 6m as the first target temporary storage section 61t when executing the relay carry-out processing.
(2) In the above embodiment, an example is described in which, after the target transport cart 1 has passed the transported article 9 to the carry-out section 7, the control system 8 designates the target article 9 to be transported by the target transport cart 1 before the target transport cart 1 arrives at the most upstream holding section 50. However, the present invention is not limited to such an example, and the control system 8 may, for example, designate the next target article 9 to be transported by the target transport cart 1 before the target transport cart 1 passes the transported article 9 to the carry-out section 7.
(3) In the above embodiment, an example was described in which the temporary storage sections 6 include the single-side temporary storage sections 6s that are arranged in a line along the second zone 22 and are locations where articles 9 are only transferred to and from transport carts 1 located in the second zone 22. However, the present invention is not limited to such an example, and the temporary storage sections 6 only need to include dual-zone temporary storage sections 6m, and may not include the single-side temporary storage sections 6s.
(4) In the above embodiment, an example was described in which the transport path 2 forms a loop path along which the transport carts 1 move in a loop in a vertical plane. However, the present invention is not limited to such an example, and the transport path 2 may form a loop path that extends in a horizontal plane, for example. In this case, the first zone 21 and the second zone 22 of the transport path 2 extend in the horizontal direction rather than the up-down direction.
(5) In the above embodiment, a specific configuration of the transport cart 1 was described with reference to FIG. 2. Specifically, the transport cart 1 includes the drive wheels 12, the first auxiliary wheels 13, and the second auxiliary wheels 14, and these types of wheels are arranged at different positions in the up-down direction. However, the transport cart 1 is not limited to the above-mentioned configuration, and only need be configured to be able to move along the transport path 2 and to be able to transfer the articles 9 between a plurality of transfer target locations. The transport cart 1 may be realized using a known configuration.
(6) Note that the configurations disclosed in the above-described embodiments may be combined with configurations disclosed in other embodiments as long as no contradiction arises. Regarding such other configurations as well, the embodiments disclosed in this specification are merely examples in all respects. Therefore, various modifications can be made as appropriate within the scope of the present disclosure.

### Summary of Embodiments

The above-described transport facility will be described below.

A transport facility according to an aspect of the present invention includes:
a first transport cart configured to transport an article;
a transport path along which the first transport cart moves in one direction;
a holding device including a plurality of holding sections configured to hold articles successively transported to the holding sections;
a carry-out section configured to perform article carry-out; and
a control system configured to control the first transport cart,
the transport path forming a loop path along which the first transport cart passes a carry-out position corresponding to the carry-out section while moving in one direction in a loop,
the transport path including:
   a first zone set downstream of the carry-out position; and
   a second zone set downstream of the first zone and upstream of the carry-out position, and extending parallel with the first zone while being spaced apart from the first zone in a specific direction,
the plurality of holding sections being arranged in a line along the first zone,
the transport facility further including a plurality of temporary storage sections arranged along the transport path and configured to temporarily store articles,
the plurality of temporary storage sections including a plurality of dual-zone temporary storage sections arranged in a line along both the first zone and the second zone at positions between the first zone and the second zone in the specific direction, and
the first transport cart being further configured to perform article transfer with the plurality of holding sections, the plurality of temporary storage sections, and the carry-out section at positions corresponding thereto along the transport path,
wherein with a target article being one of the articles held by the plurality of holding sections, a non-target article being an article other than the target article among the articles held by the plurality of holding sections, a target holding section being the holding section in which the target article is held, and a non target holding section being the holding section in which the non-target article is held,
in a case where the target article is to be transported to the carry-out section by the first transport cart, in response to presence of an empty dual-zone temporary storage section downstream of the target holding section in the first zone, the control system executes, using the first transport cart, relay carry-out processing including setting the empty dual-zone temporary storage section as a first target temporary storage section, receiving the target article from the target holding section and passing the target article to the first target temporary storage section in the first zone, and then receiving the target article from the first target temporary storage section in the second zone and passing the target article to the carry-out section, and
while the control system executes the relay carry-out processing, in response to presence of the non target holding section downstream of a position where the target article was passed to the first target temporary storage section in the first zone and presence of an empty temporary storage section downstream of the non-target holding section and upstream of a position where the target article is to be received from the first target temporary storage section in the second zone, the control system executes, using the first transport cart, intermediate transport processing including setting the empty temporary storage section as a second target temporary storage section, and, during the relay carry-out processing, receiving the non-target article from the non-target holding section and passing the non-target article to the second target temporary storage section.

According to this configuration, the target article can be temporarily placed in a temporary storage section that is closer to the carry-out section than the holding section is. After placing the target article in the temporary storage section, while moving without transporting the target article, the transport cart can receive a non-target article from a holding section and place the non-target article in another temporary storage section. Thereafter, the transport cart can receive the target article that was placed in the temporary storage section in the second zone, and appropriately transport the target article to the carry-out section. In the above, the non-target article placed in another temporary storage section can become a target article for another transport cart, thus making it possible to shorten the transport distance traveled by the other transport cart to transport the non-target article to the carry-out section. In this way, according to the above configuration, the target article can be appropriately transported from the target holding section to the carry-out section, and the non-target article can be moved to a position closer to the carry-out section while the transport cart moves along the path from the target holding section to the carry-out section. Therefore, it is possible to improve the overall transport efficiency when transporting articles to the carry-out section in the facility.

It is preferable that while the control system executes the relay carry-out processing, in response to presence of a plurality of empty dual-zone temporary storage sections downstream of the target holding section in the first zone, the control system sets a most upstream dual-zone temporary storage section among the plurality of empty dual-zone temporary storage sections as the first target temporary storage section.

According to this configuration, the position where the transport cart places the target article in the first target temporary storage section can be set further upstream. This makes it possible to secure a wider range of the transport path in which the transport cart, which continues to move along the transport path thereafter, can transport the non-target article.

It is preferable that in a case of transporting the target article from the target holding section to the carry-out section using the first transport cart, in response to absence of an empty dual-zone temporary storage section downstream of the target holding section in the first zone, the control system executes, using the first transport cart, direct carry-out processing including receiving the target article from the target holding section, directly transporting the target article to the carry-out position, and passing the target article to the carry-out section.

Depending on the situation, there may be no empty dual-zone temporary storage section downstream of the target holding section in the first zone. According to the above configuration, in such a situation, by executing the direct carry-out processing, it is possible to appropriately transport the target article from the target holding section to the carry-out section without transporting a non-target article.

It is preferable that in response to presence of the non-target holding section upstream of the target holding section in the first zone and presence of an empty temporary storage section downstream of the non target holding section and upstream of the target holding section, the control system executes, using the first transport cart, preliminary transport processing including setting the empty temporary storage section as a third target temporary storage section, and, before receiving the target article from the target holding section, receiving the non-target article from the non-target holding section and passing the non-target article to the third target temporary storage section.

According to this configuration, by executing the preliminary transport processing, it is possible to move the non-target article to a position closer to the carry-out section while the transport cart moves in order to arrive at the target holding section.

It is preferable that in response to presence of a plurality of the non-target holding sections, each time the first transport cart arrives at any of the plurality of non-target holding sections, the control system determines presence or absence of an empty temporary storage section capable of receiving the non-target article held by the non-target holding section at which the first transport cart arrived.

According to this configuration, whether or not a non-target article is to be transported can be determined according to the status of the temporary storage section at the time when the transport cart is able to receive the non-target article from the non-target holding section.

It is preferable that the control system is further configured to set, as an equivalent article, an article held by one of the temporary storage sections and deemed to be equivalent to the target article, and, in a case where the control system can execute the intermediate transport processing with the equivalent article being deemed to be the target article and with the temporary storage section holding the equivalent article being deemed to be the first target temporary storage section, the control system deems the equivalent article to be the target article and deems temporary storage section holding the equivalent article to be the first target temporary storage section, and executes the relay carry-out processing and the intermediate transport processing.

According to this configuration, it is possible to increase the number of options available when transporting an article to the carry-out section or one of the temporary storage sections, thereby increasing the possibility of being able to execute the relay carry-out processing and the intermediate transport processing.

It is preferable that the plurality of temporary storage sections further include a single-side temporary storage section arranged along the second zone and configured to perform article transfer with only the first transport cart in the second zone, and
in the intermediate transport processing, the control system selects the second target temporary storage section from among the dual-zone temporary storage sections and the single-side temporary storage section.

According to this configuration, it is possible to increase the number of options available when transporting the non-target article to a temporary storage section, thereby increasing the possibility of being able to execute the intermediate transport processing.

It is preferable that the transport facility further includes:
a second transport cart,
wherein with both the first transport cart and the second transport cart being a target transport cart, the control system designates the target article to be transported by the target transport cart at a time that is after the target transport cart has passed a transported article to the carry-out section and before the target transport cart arrives at a holding section at a most upstream location.

According to this configuration, it is possible to appropriately transport the target articles transported by each of the transport carts moving in a loop along the transport path.

### INDUSTRIAL APPLICABILITY

The technology disclosed herein can be used in a transport facility that includes transport carts for transporting articles, a transport path along which the transport carts move in one direction, a carry-out section for carrying out articles, and a control system for controlling the transport carts.

### Description of Reference Signs

100 Transport facility
1 Transport cart
2 Transport path
21 First zone
22 Second zone
5 Holding device
50 Holding section
6 Temporary storage section
6m Dual-zone temporary storage section
6s Single-side temporary storage section
61t First target temporary storage section
62t Second target temporary storage section
63t Third target temporary storage section
7 Carry-out section
70 Carry-out position
8 Control system
9 Article
X Specific direction

1. A transport facility comprising:
a first transport cart configured to transport an article;
a transport path along which the first transport cart moves in one direction;
a holding device comprising a plurality of holding sections configured to hold articles successively transported to the holding sections;
a carry-out section configured to perform article carry-out; and
a control system configured to control the first transport cart, and
wherein:
the transport path forms a loop path along which the first transport cart passes a carry-out position corresponding to the carry-out section while moving in one direction in a loop,
the transport path comprises:
a first zone set downstream of the carry-out position; and
a second zone set downstream of the first zone and upstream of the carry-out position, and extending parallel with the first zone while being spaced apart from the first zone in a specific direction,
the plurality of holding sections is arranged in a line along the first zone,
the transport facility further comprises a plurality of temporary storage sections arranged along the transport path and configured to temporarily store articles,
the plurality of temporary storage sections comprises a plurality of dual-zone temporary storage sections arranged in a line along both the first zone and the second zone at positions between the first zone and the second zone in the specific direction, and
the first transport cart is further configured to perform article transfer with the plurality of holding sections, the plurality of temporary storage sections, and the carry-out section at positions corresponding thereto along the transport path,
a target article is one of the articles held by the plurality of holding sections, a non-target article is an article other than the target article among the articles held by the plurality of holding sections, a target holding section is the holding section in which the target article is held, and a non-target holding section is the holding section in which the non-target article is held,
in a case where the target article is to be transported to the carry-out section by the first transport cart, in response to presence of an empty dual-zone temporary storage section downstream of the target holding section in the first zone, the control system executes, using the first transport cart, relay carry-out processing comprising setting the empty dual-zone temporary storage section as a first target temporary storage section, receiving the target article from the target holding section and passing the target article to the first target temporary storage section in the first zone, and then receiving the target article from the first target temporary storage section in the second zone and passing the target article to the carry-out section, and
while the control system executes the relay carry-out processing, in response to presence of the non-target holding section downstream of a position where the target article was passed to the first target temporary storage section in the first zone and presence of an empty temporary storage section downstream of the non-target holding section and upstream of a position where the target article is to be received from the first target temporary storage section in the second zone, the control system executes, using the first transport cart, intermediate transport processing comprising setting the empty temporary storage section as a second target temporary storage section and, during the relay carry-out processing, receiving the non-target article from the non-target holding section and passing the non-target article to the second target temporary storage section.

2. The transport facility according to claim 1,
wherein while the control system executes the relay carry-out processing, in response to presence of a plurality of empty dual-zone temporary storage sections downstream of the target holding section in the first zone, the control system sets a most upstream dual-zone temporary storage section among the plurality of empty dual-zone temporary storage sections as the first target temporary storage section.

3. The transport facility according to claim 1,
wherein in a case of transporting the target article from the target holding section to the carry-out section using the first transport cart, in response to absence of an empty dual-zone temporary storage section downstream of the target holding section in the first zone, the control system executes, using the first transport cart, direct carry-out processing comprising receiving the target article from the target holding section, directly transporting the target article to the carry-out position, and passing the target article to the carry-out section.

4. The transport facility according to claim 1,
wherein in response to presence of the non-target holding section upstream of the target holding section in the first zone and presence of an empty temporary storage section downstream of the non-target holding section and upstream of the target holding section, the control system executes, using the first transport cart, preliminary transport processing comprising setting the empty temporary storage section as a third target temporary storage section and, before receiving the target article from the target holding section, receiving the non-target article from the non-target holding section and passing the non-target article to the third target temporary storage section.

5. The transport facility according to claim 1,
wherein in response to presence of a plurality of the non-target holding sections, each time the first transport cart arrives at any of the plurality of non-target holding sections, the control system determines presence or absence of an empty temporary storage section capable of receiving the non-target article held by the non-target holding section at which the first transport cart arrived.

6. The transport facility according to claim 1,
wherein the control system is further configured to set, as an equivalent article, an article held by one of the temporary storage sections and deemed to be equivalent to the target article and, in a case where the control system can execute the intermediate transport processing with the equivalent article being deemed to be the target article and with the temporary storage section holding the equivalent article being deemed to be the first target temporary storage section, the control system deems the equivalent article to be the target article and deems temporary storage section holding the equivalent article to be the first target temporary storage section, and executes the relay carry-out processing and the intermediate transport processing.

7. The transport facility according to claim 1,
wherein the plurality of temporary storage sections further comprises a single-side temporary storage section arranged along the second zone and configured to perform article transfer with only the first transport cart in the second zone, and
wherein in the intermediate transport processing, the control system selects the second target temporary storage section from among the dual-zone temporary storage sections and the single-side temporary storage section.

8. The transport facility according to claim 1, further comprising:
a second transport cart, and
wherein with both the first transport cart and the second transport cart being a target transport cart, the control system designates the target article to be transported by the target transport cart at a time that is after the target transport cart has passed a transported article to the carry-out section and before the target transport cart arrives at a holding section at a most upstream location.
